(19) United States
(12) Patent Application Publication
(10) Pub. No.: US 2024/0125292 A1
(43) Pub. Date: Apr. 18, 2024

(54) INJECTOR WITH INTEGRATED FILTER

(71) Applicant: Robert Bosch GmbH, Stuttgart (DE)

(72) Inventor: Franz Thoemmes, Bietigheim-Bissingen (DE)

(21) Appl. No.: 18/546,303

(22) PCT Filed: Apr. 25, 2022
(86) PCT No.: PCT/EP2022/060857

§ 371 Date: Aug. 14, 2023

(30) Foreign Application Priority Data
May 18, 2021 (DE) 10 2021 205 042.5

(51) Int. Cl. F02M 21/02

(52) U.S. Cl. CPC F02M 21/0227; F02M 21/0269; F02M 21/0281; F02M 21/0296; F02M 61/165

(57) ABSTRACT

An injector for injecting a fluid. In injector includes a filter for filtering the fluid to be injected. The filter is arranged in a tubular section of the injector. The filter has a sleeve and a filter body. The sleeve holds the filter body in the tubular section. The sleeve has a securing section and a holding section. The securing section is connected to the filter body. The holding section holds the sleeve in the tubular section of the injector. The filter body or parts of the filter body are arranged exclusively within the securing section.

### FIELD

The present invention relates to an injector for injecting a fluid, in particular a gaseous or liquid fuel, or urea or water, for an internal combustion engine.

### CROSS REFERENCE

Injectors for internal combustion engines are available in the related art in different designs. In fuel injectors, for example, fuel is injected into a combustion chamber via fine through-openings. Modern injectors are manufactured with the highest precision and must be protected from damage and wear caused by particles in the fuel. Filters are usually used for this purpose. Here it is conventional to integrate a filter even directly in the injector, preferably in an inflow region of the fuel into the injector. The components of the injector can thus be protected from damage caused by particles in the fluid to be injected. However, such filters within the injector lead to undesirable flow losses. For example, in order to provide the exactly correct injection quantity for fuel injectors, the flow losses caused by the filter are subject to the tightest tolerances. However, this cannot always be ensured satisfactorily during the production and assembly of the injector. In addition, there is often a risk of damaging parts of the filter by excessively high forces, in particular due to manufacturing tolerances.

### SUMMARY

An injector according to the present invention may have the advantage that an assembly of the injector, in particular of a filter of the injector, can be simplified and made possible with significantly reduced probability of unintentional damage to the filter. Furthermore, a robustness of the injector can be improved overall.

According to an example embodiment of the present invention, this may be achieved by the injector comprising a filter for filtering the fluid to be injected, wherein the filter is arranged in a tubular section of the injector, and wherein the filter has a sleeve and a filter body. The sleeve holds the filter body in the tubular section. The sleeve has a securing section and a holding section. The securing section is connected to the filter body, and the holding section holds the sleeve, and thus on the filter, in the tubular section of the injector. The filter body or partial regions of the filter body are here arranged exclusively within the securing section of the sleeve.

In other words, according to an example embodiment of the present invention, the filter is made up of two parts that are fixedly connected to one another, namely the filter body, in which preferably a filter insert which brings about the filtering of the fluid is integrated, and the sleeve, which is provided for fastening the filter body in the tubular section of the injector. In particular, the tubular section forms a stationary component of the injector. The sleeve has two different sections, namely the holding section and the securing section. The filter body or partial regions of the filter body are arranged exclusively within the securing section, in particular in relation to an axial direction of the sleeve. In other words, within the holding section there is no material of the filter body. Preferably, the holding section and the securing section are thus arranged in relation to the axial direction of the sleeve without overlapping, in other words axially separated from one another.

The special design of the sleeve with the special relative arrangement of the filter body exclusively within the securing section thereby brings about the advantage of a functional separation of the holding section and the securing section. That is to say, due to the axial separation of the holding section and the securing section, these two sections can each perform their fastening function in an optimal manner independently of one another. It is particularly advantageous here that manufacturing tolerances of the tubular section and/or sleeve have little to no effect on the holding function of the securing section on the filter body. In particular, damage to the filter body, for example, due to deformation of the sleeve caused by manufacturing tolerances, can thus be avoided. In addition, it is possible to design the sleeve such that a press-in force required for pressing into the tubular section is only slightly dependent on a different oversize between the tubular section and the holding section, for example due to manufacturing tolerances. In particular, this is made possible by the filter body not restricting a free deformation of the holding section.

Example embodiments and preferred developments of the present invention and disclosed herein.

According to an example embodiment of the present invention, the sleeve is preferably made of metal, particularly preferably brass or steel. The sleeve is preferably a deep-drawn component. As a result, the sleeve can be produced particularly simply and inexpensively. In addition, the desired mechanical properties of the holding section can be adapted particularly flexibly and precisely, for example by corresponding adjustment of a wall thickness of the sleeve, for example in order to ensure optimum deformation properties.

According to an example embodiment of the present invention, the filter body is preferably made of plastics material. The filter body is preferably an injection-molded component. As a result, the filter body can also be designed particularly simply and inexpensively and with flexible geometry.

Particularly preferably, according to an example embodiment of the present invention, the securing section of the sleeve and the filter body are connected to one another by the filter body being at least partially cast into the securing section. In particular, the filter body is cast therein on an inner side of the securing section. At least the holding section of the sleeve thus projects beyond the filter body in the axial direction. The functional separation of the holding section and the securing section can thus be ensured in a particularly simple manner.

Further preferably, according to an example embodiment of the present invention, a press connection is formed between the holding section and the tubular section. The press connection causes the filter to be fastened within the tubular section. The axial separation of the holding section and the securing section of the sleeve thus ensures that the press connection does not cause any strong mechanical loading of the filter body. This is preferably ensured by the holding section being designed such that it can deform plastically, in particular in the case of a greater oversize of the sleeve relative to the tubular section. This leads in particular to a press-in force being substantially independent of the oversize, and thus also to a secure and optimally dimensioned press connection always being ensured even in the case of higher manufacturing tolerances.

According to an example embodiment of the present invention, the holding section preferably extends over at least 10% and at most 40%, particularly preferably 20%, of an entire axial length of the sleeve. Particularly preferably, the holding section has an axial length of 0.6 mm for an entire axial length of the sleeve of 3 mm. As a result, the holding section only forms a comparatively small region of the sleeve, which has a particularly advantageous effect on a simple installation of the sleeve and thus of the filter in the tubular section of the injector.

Particularly preferably, according to an example embodiment of the present invention, the holding section has a larger outer diameter than the securing section and than the filter body. That is to say, the holding section has the largest outer diameter of the entire filter. A mechanical contact of the filter with the tubular section of the injector is thus present exclusively in the region of the holding section.

According to an example embodiment of the present invention, the sleeve preferably also has a connecting section which connects the securing section and the holding section to one another. That is to say, the connecting section is located between the securing section and the holding section, which thus also brings about an additional axial distance between the holding section and the securing section. As in the case of the holding section, within the connecting section there is also no material of the filter body. In order to provide easier assembly, the connecting section can also serve as a guide when the filter is being inserted into the tubular section of the injector.

Preferably, according to an example embodiment of the present invention, at least a part of the connecting section expands radially in the direction of the holding section. For example, at least a part of the connecting section can be designed to widen conically. As a result, the connecting section can serve particularly advantageously as a guide during the insertion of the filter into the tubular section. In addition, a deformability of the sleeve, for example by length and/or by the degree of widening of the connecting section, can be adjusted.

According to an example embodiment of the present invention, particularly preferably, the holding section has a wall thickness of at least 0.1 mm to a maximum of 0.5 mm, preferably of at least 0.2 mm to a maximum of 0.3 mm. In particular, the entire sleeve has over its entire axial length a wall thickness of at least 0.1 mm to a maximum of 0.5 mm, preferably of at least 0.2 mm to a maximum of 0.3 mm. That is to say, the holding section, in particular the entire sleeve, is comparatively thin-walled, as a result of which, in the case of a reliable fastening option, it can be made possible simply and inexpensively for a comparatively low press-in force to result in the holding section, even in the case of a greater oversize.

According to an example embodiment of the present invention, the injector preferably further comprises a closing element for exposing and closing at least one through-opening in a sealing seat, a restoring element which is designed to apply to the closing element a restoring force for resetting as well as a closing force, and an injector sleeve which is arranged in an operative connection between the filter and the restoring element in the axial direction of the injector. The restoring element is supported directly or indirectly on the injector sleeve. In this case, a final axial position of the restoring element is determined by the position of the installed filter in the injector, since the position of the filter also determines the position of the injector sleeve on which the restoring element is supported directly or indirectly. Particularly preferably, the sleeve is held in the injector at a stationary component, namely in the tubular section, by means of a press fit. A particular advantage is that the filter can be installed in the injector as the final component, so that damage or geometric deviations of the filter cannot occur due to further assembly steps, such as plastic overmolding of the injector or the like.

According to an example embodiment of the present invention, The injector sleeve is preferably located directly in contact with the restoring element and directly in contact with the filter. As a result, the number of components is kept as low as possible and a rapid and simple assembly is made possible. Furthermore, this prevents production-related tolerances adding up and having an undesired effect on an end position of the injector sleeve and thus a pretensioning force of the restoring element.

According to an example embodiment of the present invention, the filter body, in particular the entire filter, is particularly preferably formed in a pot shape with a bottom region and a lateral region, wherein the bottom region is arranged in the direction of the injector sleeve. As a result, a rigid construction of the injector is made possible and an assembly tool of the filter can be positioned in particular within the pot-shaped filter interior and thus additionally contribute to stiffening the filter during assembly.

According to an example embodiment of the present invention, the filter preferably has no filter openings in the bottom region. The bottom region is thus preferably made of a solid material, which further improves the rigidity of the filter. The fuel flows into the pot-shaped filter interior and then through the filter via filter openings in the lateral region.

Further preferably, according to an example embodiment of the present invention, at least one slit, in particular two slits, is provided in the bottom region of the filter in order to provide a fluid connection into the inner region of the sleeve. The two slits are preferably arranged opposite one another.

The present invention also preferably relates to a method for assembling an injector with a closing element, a restoring element, an injector sleeve and a filter. According to an example embodiment of the present invention, in an assembly step, the filter is installed in the injector in such a way that an installation position of the filter also defines an installation position of the injector sleeve, and a pretensioning force of the restoring element on the closing element in the closed injector is defined. A restoring force and a closing force of the restoring element on the closing element can thus be set according to a positioning of the filter.

The step of installing the filter is preferably the final assembly step during assembly of the injector. In particular, if the injector has a plastic overmolding for an electrical plug or the like, the final step for producing the injector is the installation of the filter.

Particularly preferably, the filter is installed in the injector by means of a stepped assembly tool. The stepped assembly tool preferably has a first and a second cylindrical region having different diameters, the first cylindrical region being arranged in the interior of the filter and the second cylindrical region being arranged at the end of the filter facing away from the bottom region of the filter, in particular at the holding section of the sleeve of the filter. As a result, damage-free installation of the filter can be ensured.

### BRIEF DESCRIPTION OF THE DRAWINGS

The present invention is described below with reference to an exemplary embodiment in conjunction with the figures. In the figures, functionally identical components are each denoted by the same reference signs.

FIG. 1 is a schematic sectional view of an injector according to a preferred exemplary embodiment of the present invention.

FIG. 2 is a sectional view of a filter of the injector of FIG. 1.

FIG. 3 is an enlarged detail of FIG. 2,

FIG. 4 is a perspective view of the filter of FIG. 2.

FIG. 5 is a simplified schematic view of a press-in force as a function of an oversize between the filter and the injector during the installation of the filter of FIG. 1.

### DETAILED DESCRIPTION OF EXAMPLE EMBODIMENTS

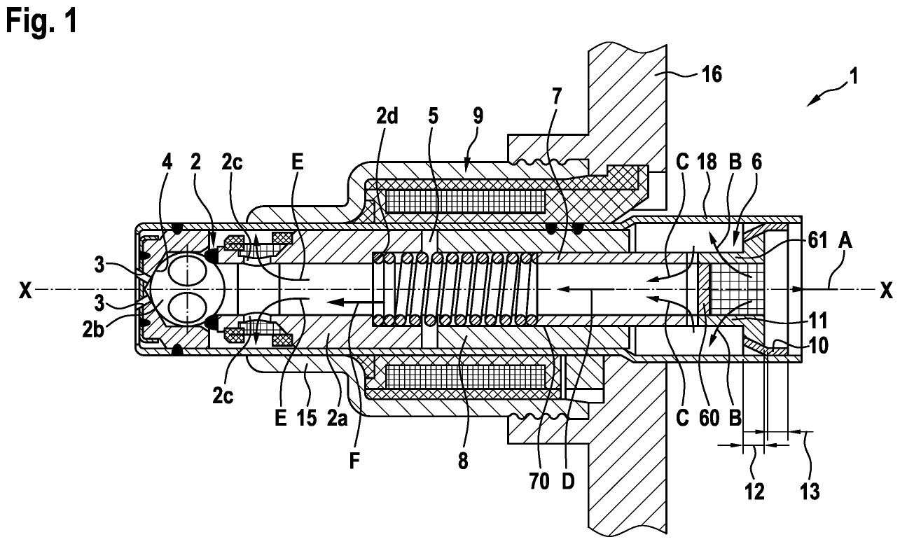

In the following, an injector 1 according to a preferred exemplary embodiment of the present invention is described in detail, with reference being made to FIGS. 1 to 5.

The injector 1 is an injector for injecting a fluid and, in the present exemplary embodiment, designed as a fuel injector for injecting a gaseous fuel into a combustion chamber of an internal combustion engine.

The injector 1 comprises a closing element 2 for exposing and closing a plurality of through-openings 3. At a first end of the injector 1, the closing element 2 seals at a sealing seat 4.

The injector 1 further comprises a restoring element 5, which is designed to apply a restoring force F to the closing element 2 when the injector 1 has been opened, and also a closing force in order to hold the injector 1 in the closed state. As can be seen from FIG. 1, the closing element 2 is a hollow valve needle 2a with a ball 2b which seals at the sealing seat 4.

FIG. 1 shows the closed state of the injector.

Furthermore, the injector 1 comprises an injector sleeve 7 through which fuel flows in the direction of the closing element 2, as well as a filter 6.

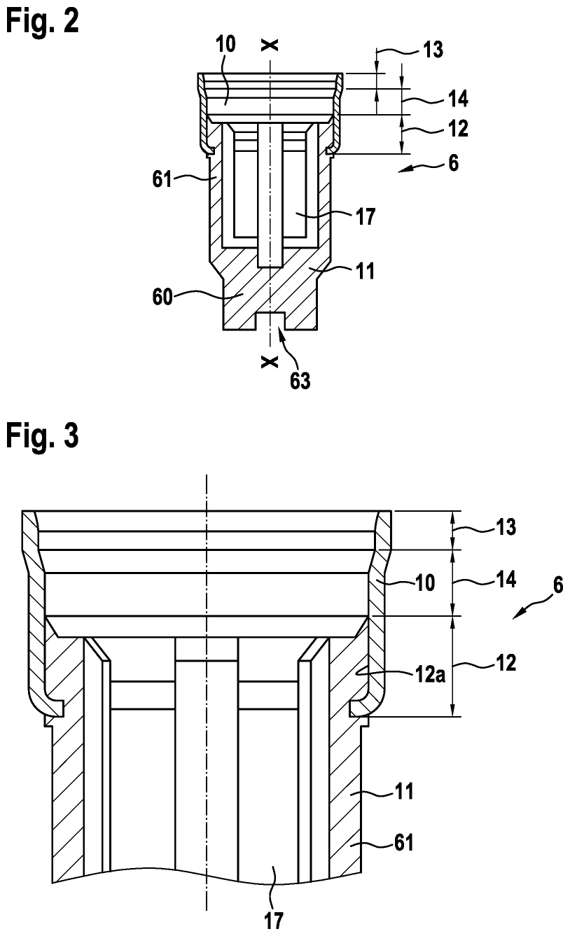

The filter 6 can be seen in detail in FIGS. 2 to 4. The filter 6 has a filter body 11 with a basically pot-shaped design and comprises a bottom region 60 and a lateral region 61.

As can be seen from FIG. 1, the filter 6 is arranged in such a way that the bottom region 60 is directed in the direction of the closing element 2, so that the fuel flows at the inflow end of the injector 1 into the interior of the pot-shaped filter and flows out of the filter 6 through the lateral region 61 where a filter fabric is arranged. By means of the filter 6, solids possibly contained in the fuel can thus be filtered out upon entering the injector 1 and collected in the pot-shaped interior of the filter 6.

The filter 6 comprises a sleeve 10 and a filter body 11. The filter body 11 is an injection-molded component made of plastics material. The, for example mesh-like, filter element 17, which is provided for filtering the fluid to be injected, is integrated into the filter body 11.

The sleeve 10 is a tubular deep-drawn component made of metal, for example brass or steel.

The sleeve 10 has a holding section 13 which is located at the axially upper end of the sleeve 10. The holding section 13 is provided here to keep the sleeve 10 in the tubular section 18 of the injector 1 (cf. FIG. 1). For this purpose, the holding section 13 of the sleeve 10 has the largest outer diameter of the entire filter 6, so that when arranged within the tubular section 18, as in FIG. 1, the holding section 13 alone is in contact with an inner wall of the tubular section 18.

In this case, the holding section 13 of the sleeve 10 is designed such that, in the installed state of the filter 6, a press connection is formed between the holding section 13 and the tubular section 18. For this purpose, the holding section 13 is designed with an oversize in comparison to the tubular section 18. As a result of the press connection, the filter 6 is thus fastened within the tubular section 18.

The sleeve 10 also has a securing section 12 which is connected to the filter body 11. Fastening section 12 and filter body 11 are connected to one another by the filter body 11 being cast into the securing section on an inner side 12a of the securing section 12 (cf. in particular FIG. 3). In other words, the filter body 11 is located inside the securing section 12 of the sleeve 10.

Furthermore, there is also a connecting section 14 between the securing section 12 and the holding section 13 which connects the securing section 12 and the holding section 13 to one another. A part of the connecting section 14 adjoining the holding section 13 is designed to widen conically. As a result, the connecting section 14 also serves for centering and guidance when the filter 6 is being inserted into the tubular section 18.

In this case, the holding section 13 and the connecting section 14 are material-free-that is to say, hollow inside. In other words, parts of the filter body 11 are located exclusively within the securing section 12, in particular when viewed in relation to the axial direction X-X, with the rest of the filter body 11 extending downward beyond the securing section 12. As a result, the holding section 13 can deform freely radially inwardly when being pressed into the tubular section 18 of the injector 1, without the filter body 11 being subjected to any strong mechanical loading.

In this way, there is an axial separation of the holding section 13 and the securing section 12, as a result of which a functional separation of the holding section 13 and the securing section 12 is achieved. This results in the advantage that, when the sleeve 10 is being pressed in by means of the holding section 13 into the tubular section 18, the holding section 13 can deform freely without the filter body 11 having to deform as well. As a result, damage, for example due to excessive pressing, to the filter body 11 can be avoided.

A particularly advantageous design of the sleeve 10 is achieved by a comparatively thin-walled configuration. For this purpose, the entire sleeve 10 has a wall thickness of 0.2 mm.

As a result of the thin-walled configuration of the sleeve 10, it is achieved that when the holding section 13 is being pressed, the latter deforms plastically, wherein, even with greater differences in the tolerances of the holding section 13 and the tubular section 18, substantially identical pressing forces occur. This relationship is shown schematically in simplified form in FIG. 5.

FIG. 5 shows a diagram 50 with a profile of a press-in force as a function of an oversize between the holding section 13 of the filter 6 and the tubular section 18 of the injector 1. The axis 51 indicates the oversize, i.e. the difference between the outer diameter of the holding section 13 and the inner diameter of the tubular section 18, and the axis 52 indicates the press-in force.

The dashed lines 53 and 54 indicate a minimum state for the design of the press connection to be achieved. The oversize 53 indicates an at least required oversize and the press-in force 53 indicates a corresponding minimum press-in force occurring in this case, which is at least present when the holding section 13 is designed while observing the manufacturing tolerances.

As can be seen in FIG. 5, the press-in force 55 actually occurring rises only slightly with a larger oversize. That is to say, even in the case of greater manufacturing tolerances and thus a greater oversize, the press-in force 55 actually occurring lies only slightly above the design state.

For a further particularly targeted design and simple assembly, the holding section 13 is designed so as to be comparatively short. In detail, the holding section 13 extends in the axial direction X-X over approximately 20% of an entire axial length of the sleeve 10 (cf. FIG. 3). As a result, the contact surface on the sleeve 10 available for the press connection is comparatively small, whereby a particularly simple installation of the filter 6 is made possible. The securing section 12, on the other hand, preferably extends over at least 30%, particularly preferably at most 50%, of the entire axial length of the sleeve 10.

The injector 1 further comprises an actuator 9, which in this exemplary embodiment is a magnetic actuator. Furthermore, a plastic overmolding 16 is provided, which is designed for arranging an electric plug (not shown) in order to supply the actuator 9 with electricity.

The function of the injector 1 is in this case such that when the actuator 9 is energized, the closing element 2 is pulled in the direction of a stationary component 8 in the interior of the injector against the spring force of the restoring element 5, wherein the ball of the closing element 2 lifts away from the sealing seat 4 and fuel can flow out via the through-openings 3.

The flow path of the fuel when the injector is open is shown in FIG. 1 by arrows A to E. The fuel flows into the pot-shaped interior of the filter 6 and out of the filter 6 via the lateral region 61 (arrow B), as a result of which the filtering process is carried out. The fuel flows onward, as indicated by the arrows C, into the interior of the injector sleeve 7 and through the cylindrical return spring 5 into the interior of the hollow closing element 2. The closing element 2 has lateral openings 2c in the end region directed toward the sealing seat 4, at which openings a second filter 15 is arranged, so that the fuel can flow out of the interior of the closing element 2, as indicated by the arrows E. When the closing element 2 now lifts away from the sealing seat 4, the fuel is able to flow past the ball of the closing element 2 into the through-openings 3.

Ensuring a reliable and precise functioning of the injector 1 requires an exact setting of the force F of the restoring element 5, with which a resetting of the closing element 2 into the closed initial state takes place, and also of a closing force of the restoring element 5, with which the closing element 2 is held in the closed state on the sealing seat 4. As can be seen from FIG. 1, a first end of the restoring element 5 is supported on the closing element 2 at a shoulder 2d and a second end of the restoring element is supported directly on the injector sleeve 7. As a result, the position of the injector sleeve 7 determines the closing force as well as the restoring force of the restoring element 5. Here, a press fit 70 is provided between the injector sleeve 7 and the stationary component 8. The position of the injector sleeve 7 in the axial direction X-X is now set by means of the filter 6.

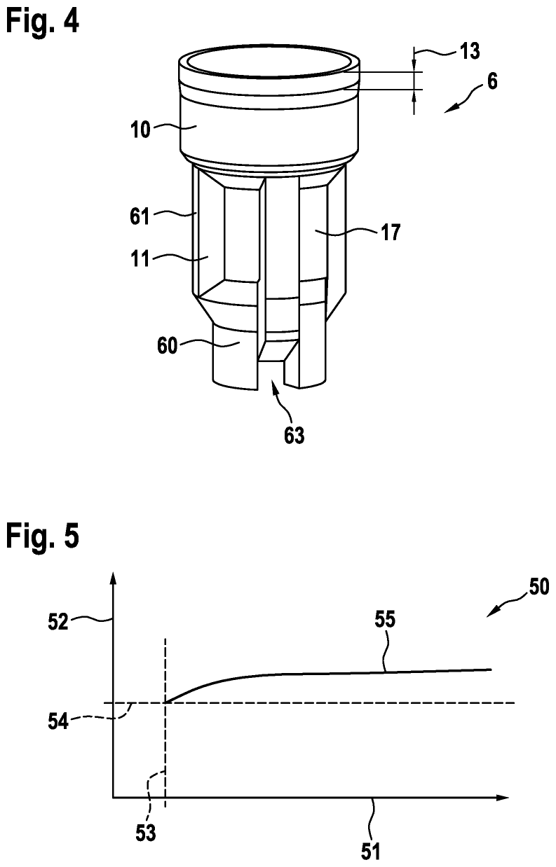

As can be seen from FIGS. 2 and 4, two wide slits 63 are formed opposite one another in the bottom region 60 of the filter body 11 of the filter. The slits 63 serve to transfer the filtered fuel into the overall assembly of the injector 1. No undesired changes in the filter and thus possibly in the flow rate, for example during production of the plastic overmolding 16 or further assembly steps, can therefore occur.

1-15. (canceled)

16. An injector for injecting a fluid, comprising:
a tubular section; and
a filter configured to filter the fluid to be injected, the filter is arranged in the tubular section of the injector, and including a sleeve and a filter body, the sleeve holding the filter body in the tubular section, the sleeve including a securing section and a holding section, the securing section is connected to the filter body, wherein the holding section holds the sleeve in the tubular section of the injector, and the filter body or parts of the filter body being arranged exclusively within the securing section.

17. The injector according to claim 16, wherein the sleeve is made of metal, the metal being brass or steel.

18. The injector according to claim 17, wherein the sleeve is a deep-drawn component.

19. The injector according to claim 16, wherein the filter body is made of plastics material.

20. The injector according to claim 19, wherein the filter body is an injection-molded component.

21. The injector according to claim 16, wherein the securing section and the filter body are connected to one another by the filter body being at least partially cast into the securing section on an inner side of the securing section.

22. The injector according to claim 16, wherein a press connection is formed between the holding section and the tubular section.

23. The injector according to claim 16, wherein the holding section extends over at least 10% and at most 40% of an entire axial length of the sleeve.

24. The injector according to claim 16, wherein the holding section has a larger outer diameter than the fastening section and than the filter body.

25. The injector according to claim 16, wherein the sleeve further includes a connecting section which connects the securing section and the holding section to one another.

26. The injector according to claim 25, wherein at least a part of the connecting section widens radially in a direction of the holding section.

27. The injector according to claim 16, wherein the holding section has a wall thickness of at least 0.1 mm to a maximum of 0.5 mm.

28. The injector according to claim 16, wherein the entire sleeve has a wall thickness of at least 0.1 mm to a maximum of 0.5 mm.

29. The injector according to claim 16, further comprising:
a closing element configured to expose and close at least one through-opening in a sealing seat;
a restoring element configured to apply to the closing element a restoring force for resetting and a closing force in order to push the closing element onto the sealing seat in a sealing manner; and
an injector sleeve which is arranged in an operative connection between the filter and the restoring element in an axial direction of the injector;
wherein the restoring element is supported on the injector sleeve; and
wherein a final axial position of the restoring element is determined by a position of the filter in the injector.

30. The injector according to claim 29, wherein the injector sleeve is directly in contact with the restoring element and directly in contact with the filter.

31. The injector according to claim 29, wherein the filter body of the filter is formed pot-shaped with a bottom region and a lateral region, wherein the bottom region is arranged in a direction of the injector sleeve.

32. The injector according to claim 31, wherein the bottom region is formed without filter openings.

33. The Injector according to claim 31, wherein the bottom region of the filter has two slits opposite one another, to provide a fluid connection for the fluid to be injected from an outer region of the filter into an inner region of the injector sleeve.
